(19) United States
(12) Patent Application Publication
(10) Pub. No.: US 2010/0032226 A1
(43) Pub. Date: Feb. 11, 2010

(54) Vehicle and vehicle exhaust pipe

(75) Inventor: Masato Yokoi, Shizuoka-Ken (JP)

Correspondence Address: RABIN & Berdo, PC, 1101 14TH STREET, NW, SUITE 500, WASHINGTON, DC, 20005, US

(73) Assignee: Yamaha Hatsudoki Kabushiki Kaisha, Shizuoka-Ken (JP)

(21) Appl. No.: 12/461,284

(22) Filed: Aug. 6, 2009

(30) Foreign Application Priority Data
Aug. 8, 2008 (JP) 2008-206369

(51) Int. Cl. B60K 13/04; B62K 11/00

(52) U.S. Cl. 180/229; 180/219; 180/309

(57) ABSTRACT

A vehicle, such as a motorcycle, can include an exhaust pipe connected to a back or rear side of an engine of the vehicle. An intermediate portion of the exhaust pipe can extend along a side of the engine from a rear portion connected to the rear side of the engine. A front portion of the exhaust pipe can extend from the intermediate portion along a front of the engine, and an exhaust portion can extend from the intermediate portion along a side of the engine opposite to the intermediate portion side.

### CROSS-REFERENCE TO RELATED APPLICATIONS

This application claims priority under 35 U.S.C. §119 from Japanese Patent Application No. 2008-206369, filed Aug. 8, 2008, the entirety of which is incorporated herein by reference

### BACKGROUND OF THE INVENTION

1. Field of the Invention

Embodiments of the present invention relate to a vehicle and an exhaust pipe for the vehicle. The vehicle can be a motorcycle, for example. More specifically, the embodiments relate to a vehicle that includes an exhaust pipe connected to a back side of an engine. The engine can be a single-cylinder engine, for example.

2. Background

There are known motorcycles that have an exhaust pipe connected to a back side of an engine. JP S60-45428 A discloses a motorcycle that includes an engine having an outlet port at a back side of the engine and an exhaust pipe connected to the outlet port. An exhaust chamber is connected to the exhaust pipe of the motorcycle and provided under a back end of the engine. The exhaust pipe of the motorcycle is formed to extend backward and downward from the outlet port of the engine.

### SUMMARY OF THE INVENTION

Embodiments of the present invention relate to a vehicle and an exhaust pipe for the vehicle. The exhaust pipe can be formed so as to have a sufficient length when connected to a back side of an engine of the vehicle.

In embodiments, the vehicle can be a motorcycle. A motorcycle according to the embodiments can include an engine and an exhaust pipe connected to a back side of the engine. The exhaust pipe can include first to third portions. The first portion can be connected to the back side of the engine, and extend forward from the back side of the engine on one side of the engine, with respect to a widthwise direction of the motorcycle. The second portion can be connected to a downstream side of the first portion and extend in front of the engine from the one side to another side, with respect to the widthwise direction of the motorcycle. The third portion can be connected to a downstream side of the second portion and extend to the back side of the engine along a body of the motorcycle. The engine can be a single-cylinder engine, for example.

With the above-described arrangement, even though the exhaust pipe is connected to the back side of the engine, the exhaust pipe can have a sufficient length.

According to the embodiments, the motorcycle can further include a head pipe and a frame portion. The frame portion can be provided ahead of the engine and extend backward and downward from the head pipe. The second portion can extend between the engine and the frame portion. With this configuration, space between the engine and the frame portion can effectively be used to provide the exhaust pipe.

Further, according to the embodiments, the engine can include a cylinder having an axial line inclined backward with respect to a substantially vertical line. In this way, weight of the engine can be balanced on a center side of the motorcycle, and the exhaust pipe can be provided in a space in front of the engine formed by the backward inclination of the axial line.

Embodiments of the invention can further relate to an exhaust pipe for a vehicle, comprising a rear portion to connect to a rear part of an engine, an intermediate portion to extend from the rear portion along a first side of the engine, a front portion to extend from the intermediate portion along a front of the engine, and an exhaust portion to extend from the front portion along a second side opposite the first side. Moreover, embodiments of the invention can relate to a vehicle exhaust pipe formed to connect to a rear part of an engine of the vehicle, and wrap around a front of the engine to exhaust toward a rear of the engine.

Other features, elements, step,s, characteristics and advantages of the present invention will become more apparent from the following detailed description of embodiments of the invention with reference to the attached drawings.

### BRIEF DESCRIPTION OF THE DRAWINGS

FIG. 1 is a left side view of a motorcycle according to a first embodiment of the present invention.

FIG. 2 is a plan view of the motorcycle according to the first embodiment.

FIG. 3 is a perspective view of a frame structure of the motorcycle according to the first embodiment, including an exhaust pipe as seen obliquely from the upper left.

FIG. 4 is a perspective view of a frame structure of the motorcycle according to the first embodiment, including the exhaust pipe as seen obliquely from the upper right.

FIG. 5 is a plan view of the exhaust pipe in the motorcycle according to the first embodiment.

FIG. 6 is a right side view of the exhaust pipe in the motorcycle according to the first embodiment.

FIG. 7 is a left side view of a motorcycle according to a second embodiment of the present invention.

FIG. 8 is a perspective view of a frame structure of the motorcycle according to the second embodiment, including an exhaust pipe as seen obliquely from the upper left.

FIG. 9 is a perspective view of frame structure of the motorcycle according to the second embodiment, including the exhaust pipe as seen obliquely from the upper right.

FIG. 10 is a plan view of the exhaust pipe in the motorcycle according to the second embodiment.

FIG. 11 is a right side view of the exhaust pipe in the motorcycle according to the second embodiment.

FIG. 12 is a left side view of a frame structure of a motorcycle and an exhaust pipe according to a third embodiment of the present invention.

FIG. 13 is a left side view of a frame structure and a structure of an exhaust chamber in a motorcycle according to a fourth embodiment of the present invention.

### DETAILED DESCRIPTION OF THE INVENTION

The invention will now be described in more detail by way of example with reference to the embodiments shown in the accompanying Figures. It should be kept in mind that the following described embodiments are only presented by way of example and should not be construed as limiting the inventive concept to any particular physical configuration. It should further be understood that “exemplary” as used herein means “serving as an example, instance or illustration.” Any aspect referred to herein as “exemplary” is not necessarily to be construed as preferred over other aspects.

Further, if used and unless otherwise stated, the terms “upper,” “lower,” “front,” “back,” “over,” “under,” and similar such terms are not to be construed as limiting the invention to a particular orientation. Instead, these terms are used only on a relative basis.

Moreover, any term of degree used herein, such as “substantially,” “essentially,” “nearly” and “approximately” means a reasonable amount of deviation of the modified word is contemplated such that the end result is not significantly changed. For example, such terms can be construed as allowing a deviation of at least 5% of the modified word if this deviation would not negate the meaning of the word the term of degree modifies.

Additionally, the following description includes references to directions, such as “front,” “ahead,” “back,” “rear,” “behind,” “right,” “left,” “upward,” “downward,” “forward,” “backward,” “widthwise,” “horizontal” and “vertical.” As used herein, these terms reflect the perspective of a person facing in the direction indicated by the arrow labeled “FWD” in the drawings, such as a rider seated on or straddling the motorcycle 1 and facing toward the front wheel 15. Thus, the arrow labeled “FWD” can indicate a back-to-front direction relative to the motorcycle 1, or an advancing direction of the motorcycle 1. A direction specified as “left” or “right” in the description refers to left or right with respect to the back-to-front or advancing direction (FWD). “Widthwise” may correspond substantially to a direction substantially transverse to the FWD or back-to-front direction. “Vertical” may refer to a direction substantially transverse to both the widthwise and back-to-front directions, and correspond substantially to “upward” and/or “downward.” “Horizontal” may refer to a direction substantially transverse to the vertical direction.

The following describes exemplary first to fourth embodiments of the present invention with reference to the accompanying drawings. As previously described, the first to fourth embodiments relate to a vehicle, such as a motorcycle, and may more particularly relate to an off-road-type motorcycle. However, embodiments of the invention are not limited to a particular type of vehicle or motorcycle. For example, embodiments of the invention can be implemented in an on-road-type motorcycle, such as a motor scooter, or in other types of vehicles such as an automobile, a tricycle, or an ATV (All Terrain Vehicle).

### First Embodiment

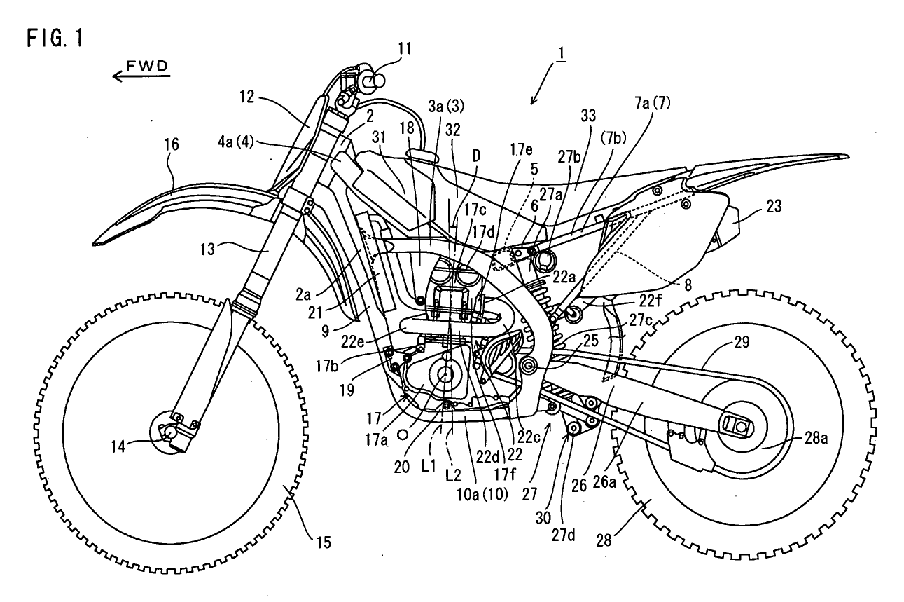

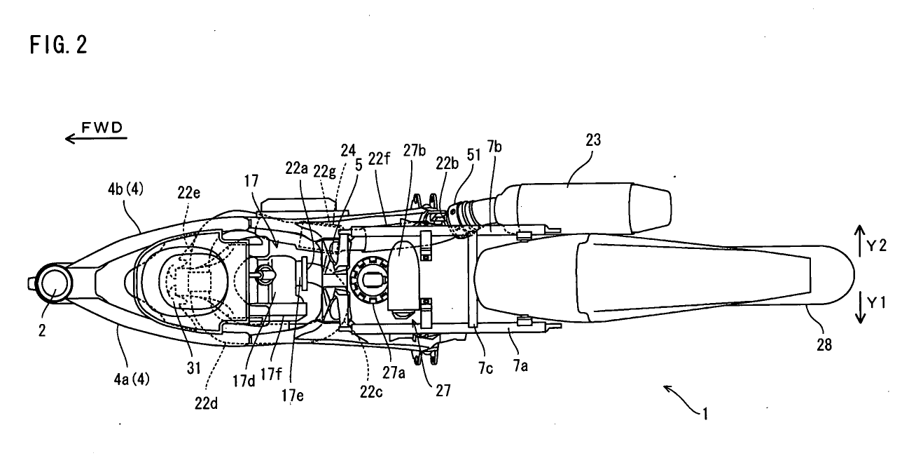

Referring to FIGS. 1 to 6, the motorcycle 1 according to the first embodiment of the present invention will be described. FIG. 1 is a left side view of the motorcycle 1. FIG. 2 is a plan view of the motorcycle 1.

Referring to FIG. 1, the motorcycle 1 can include a head pipe 2 in front of a motorcycle body. A handle 11 can be attached at an upper part of the head pipe 2 so that the handle 11 can rotate, e.g., in a substantially horizontal direction. A race number plate 12 that can cover a front of the head pipe 2 can be attached in front of the head pipe 2. A pair of front forks 13 can be provided under the head pipe 2.

An axle 14 can be fixed at a lower end of the pair of front forks 13. A front wheel 15 can be rotatably provided at the axle 14. A front fender 16 that can cover a top of the front wheel 15 can be provided above the front wheel 15.

A connecting frame 2a can be connected to the head pipe 2. The connecting frame 2a can be formed to extend backward and downward from the head pipe 2. The connecting frame 2a can be connected with a main frame 3. A tank frame 4 can be provided between the main frame 3 and the head pipe 2. As shown in FIG. 2, the tank frame 4 can include left and right tank frames 4a and 4b.

Referring back to FIG. 1, an air cleaner 31 can be provided on the tank frame 4. A fuel tank 32 formed, e.g., from resin, can be provided to extend behind the air cleaner 31 at a back side of the air cleaner 31. A front part of a seat 33 can be provided on the fuel tank 32. The seat 33 can be formed to extend behind the fuel tank 32. An engine 17 can be provided under the main frame 3.

The main frame 3 can be provided with a pivot axis 25. A rear arm 26 can be supported at the pivot axis 25. The rear arm 26 can be supported so that it can rotate in a substantially or approximately vertical direction around the pivot axis 25. The rear arm 26 can include a left arm 26a and a right arm that is not shown. A rear wheel 28 can be rotatably provided at a rear end of the rear arm 26.

A driven sprocket 28a that rotates together with the rear wheel 28 can be provided at the rear wheel 28. A chain 29 can be wound around the driven sprocket 28a and the chain 29 can be driven by the engine 17. The driven sprocket 28a and the chain 29 can be provided on a left side in a widthwise direction of the motorcycle 1.

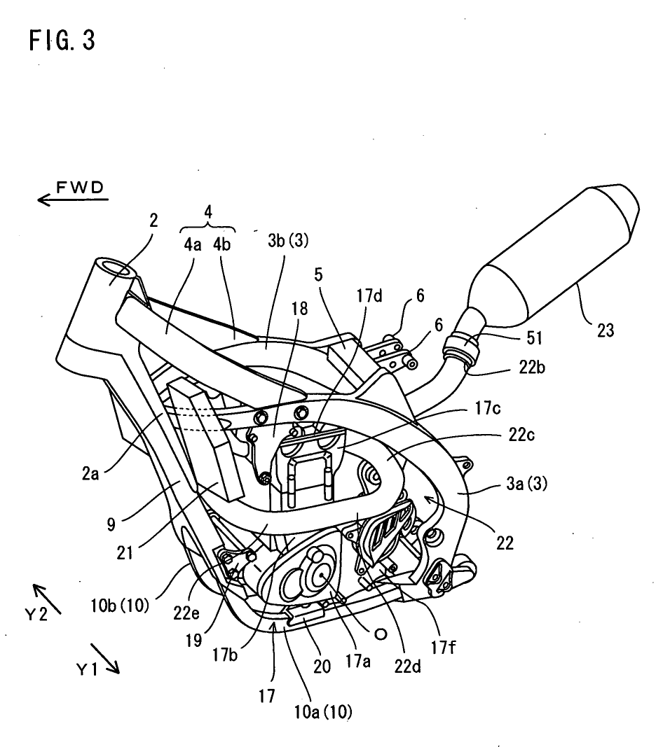

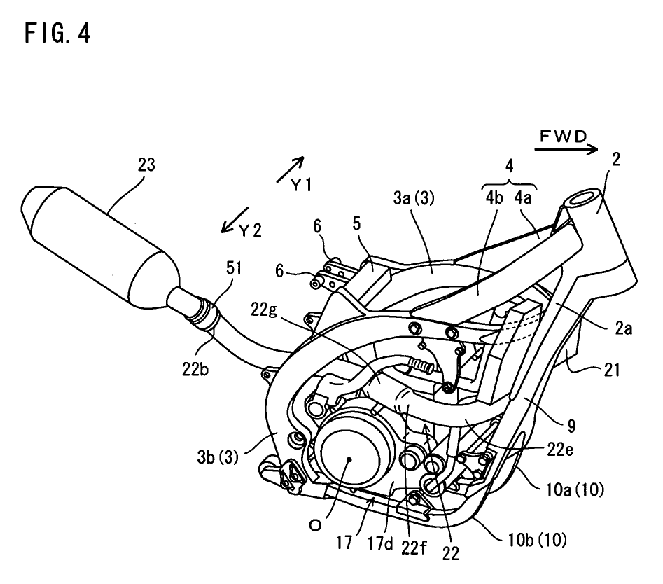

FIG. 3 is a perspective view of a frame structure of the motorcycle 1 including an exhaust pipe seen obliquely from the upper left. FIG. 4 is a perspective view of a frame structure of the motorcycle 1 including the exhaust pipe seen obliquely from the upper right.

As shown in FIG. 3, the connecting frame 2a can be connected with a left main frame 3a of the main frame 3. As shown in FIG. 4, the connecting frame 2a can be connected with a right main frame 3b of the main frame 3. The left and right main frames 3a and 3b can extend backward and downward in a curve.

Left and right tank frames 4a and 4b can be provided between a rear part of the head pipe 2 and upper parts of the left and right main frames 3a and 3b, respectively. A tank frame 4 including the left and right tank frames 4a and 4b can support a front part of the fuel tank 32 as shown in FIG. 1. The air cleaner 31 can be attached between the left and right tank frames 4a and 4b as shown in FIG. 2.

As shown in FIGS. 3 and 4, upper parts of the left and right main frames 3a and 3b can be connected by a connection member 5. The connection member 5 can include a support member 6 that projects backward. The support member 6 can be connected with left and right seat frames 7a and 7b that extend backward and upward as shown in FIGS. 1 and 2. The support member 6 can be also connected with a rear cushioning member 27.

As shown in FIG. 2, a connection plate 7c that connects the left and right seat frames 7a and 7b can be provided between the left and right seat frames 7a and 7b. A seat frame 7 can include the left and right seat frames 7a and 7b and the connection plate 7c. As shown in FIG. 1, a back stay 8 can be attached between the main frame 3 and the seat frame 7.

As shown in FIGS. 3 and 4, a down frame 9 that extends backward and downward can be connected to a lower end of the head pipe 2. A lower frame 10 can include lower left and right frames 10a and 10b, which can be connected to a lower end of the down frame 9. The lower left and right frames 10a and 10b can be arranged to extend backward and connect to lower ends of the left and right main frames 3a and 3b.

As shown in FIG. 1, the engine 17 can be arranged under the main frame 3 and behind the down frame 9. The engine 17 according to the embodiment under discussion can be a single-cylinder engine (e.g., an engine having one cylinder), for example. The engine 17 can be fixed by a support plate 18 fixed to the main frame 3, a support plate 19 fixed to the down frame 9, and a support plate 20 fixed to the lower frame 10. As shown in FIG. 1, in the engine 17, a cylinder axial line L1 can be inclined backward by an angle D (such as 5 degrees) with respect to a substantially vertical line L2.

The engine 17 can include a crank case 17a that stores a rotating crankshaft (not shown), a cylinder part 17b, a cylinder head 17c provided on the cylinder part 17b, and a cylinder head cover 17d. The cylinder part 17b of the engine 17 can include one cylinder (not shown). The cylinder head 17c of the engine 17 can include an intake port (not shown) that extends ahead of the engine 17 and an exhaust port 17e that extends behind the engine 17. More specifically, the engine 17 can be a front-intake rear-exhaust type single-cylinder engine.

A radiator 21 used to cool the engine 17 can be provided between the down frame 9 and the engine 17.

As shown in FIGS. 1 and 2, the rear cushioning member 27 (e.g., a shock absorber) can be provided behind the main frame 3 and in front of the rear wheel 28. The rear cushioning member 27 can include a main body 27a and a sub tank 27b connected to the main body 27a. A compression coil spring 27c can be provided about an outer circumference of the main body 27a of the rear cushioning member 27. The main body 27a can be compressed and expanded in an approximately vertical direction so that it absorbs impact given when the rear wheel 28 moves in an approximately vertical direction. The main body 27a can be rotatably attached to the support member 6, so that, for example, the main body 27a can rotate in an approximately or substantially vertical direction.

A lower part of the main body 27a can be coupled to the rear arm 26 through a link mechanism 30. An attachment part 27d can be provided at a lower side of the main body 27a. The attachment part 27d can be attached to the link mechanism 30 through a connection member. In this way, impact caused when the rear arm 26 and the rear wheel 28 move in a vertical direction can be absorbed.

As shown in FIG. 1, an engine side end portion 22a of an exhaust pipe 22 that carries exhaust gas out from the engine 17 can be connected to a back surface of the cylinder head 17c of the engine 17. As shown in FIG. 3, the exhaust pipe 22 can extend forward from a back side of the engine 17 and then around the engine 17. As shown in FIG. 4, the exhaust pipe 22 can further extend from a front of the engine 17 to a back side of the engine 17 where a muffler 23 can be provided. Thus, for example, the exhaust pipe 22 can be said to “wrap around” the engine 17 to exhaust toward a rear of the engine.

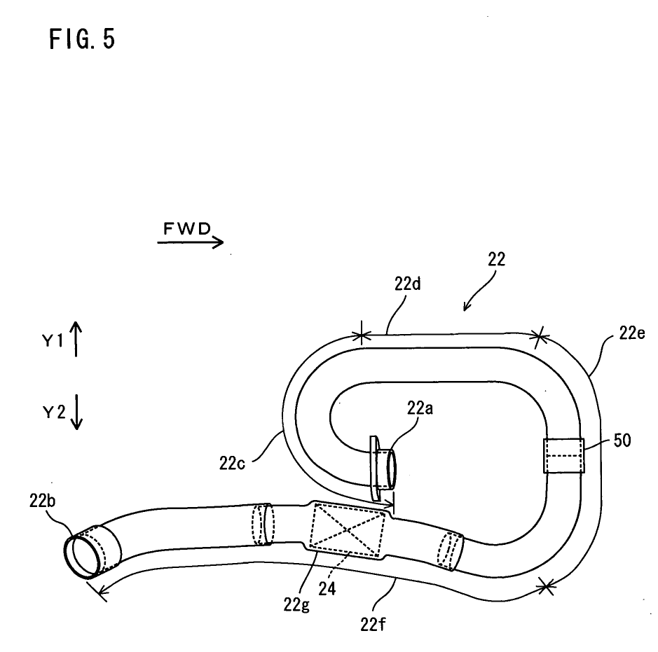

FIG. 5 is a plan view of the exhaust pipe 22 in the motorcycle 1. As shown in FIGS. 2 and 5, the engine side end portion 22a of the exhaust pipe 22 can be connected to a back side of the engine 17. The exhaust pipe 22 can include a rear or U-shaped portion 22c that extends backward (in a direction approximately opposite to a direction of the arrow FWD) from the end portion 22a and is then curved to the left. The exhaust pipe 22 can include a left side or intermediate portion 22d that extends forward on a left side (a side indicated by the arrow Y1) of the engine 17. The exhaust pipe 22 can include a front side portion 22e that is connected to a downstream side (front end) of the left side portion 22d and extends in front of the engine 17 to reach a right side (a side indicated by the arrow Y2) of the engine 17. The exhaust pipe 22 can include a right side or exhaust portion 22f that is connected to a downstream side of the front side portion 22e and extends backward on the right side (a side indicated by the arrow Y2) of the engine 17. An exhaust side end portion 22b of the exhaust pipe 22 can be connected with the muffler 23.

As shown in FIG. 5, the front side portion 22e of the exhaust pipe 22 can be divided into left and right sections near the center of the front side portion 22e. The two sections of the front side portion 22e can be connected by a fastening member 50. The U-shaped portion 22c, the left side portion 22d and the left section of the front side portion 22e can be formed to be continuous. Likewise, the right section of the front side portion 22e and a front part of the right side portion 22f can be formed to be continuous.

As shown in FIGS. 1 to 4, the front side portion 22e of the exhaust pipe 22 can be arranged to extend between the cylinder part 17b of the engine 17 and the down frame 9. The front side portion 22e can be arranged above the crank case 17a and under the radiator 21. In this way, the front side portion 22e can be arranged to extend in the region surrounded by the down frame 9, the engine 17 and the radiator 21.

As shown in FIG. 2, the engine 17 can be provided with a cam chain chamber 17f laterally expanded at a left side surface (on a side indicated by the arrow Y1) of the cylinder part 17b. The cam chain chamber 17f can store a cam chain used to drive a cam controlling opening/closing of an intake valve and an exhaust valve that are not shown.

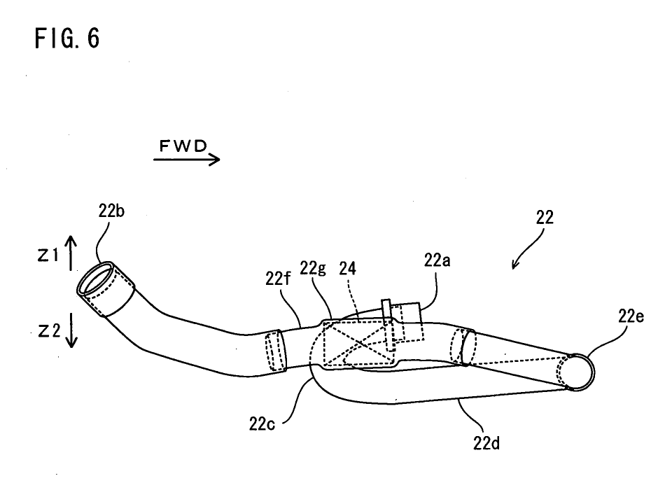

FIG. 6 is a right side view of the exhaust pipe 22. The U-shaped portion 22c of the exhaust pipe 22 is formed to extend downward (in a direction indicated by an arrow Z2) from the end portion 22a to the left side portion 22d. As shown in FIG. 6, the right side portion 22f of the exhaust pipe 22 can be formed to extend backward and upward (in a direction indicated by an arrow Z1) from the front side portion 22e.

As shown in FIG. 1, the left side portion 22d and the front side portion 22e of the exhaust pipe 22 can be arranged above a bottom surface of the engine 17. More specifically, the left side portion 22d and the front side portion 22e can be arranged above the crank axial center O of the engine 17. As shown in FIG. 6, a front end of the left side portion 22d and the front side portion 22e can be arranged in the lowest position among all portions of the exhaust pipe 22 except U-shaped portion 22c. In embodiments, a front end of the left side portion 22d and the front side portion 22e can be arranged in the lowest position among all portions of the exhaust pipe 22. Substantially an entirety of, e.g., all the portions of the exhaust pipe 22 can be arranged above the bottom surface of the engine 17. More specifically, substantially all the portions of the exhaust pipe 22 can be arranged above the crank axial center O of the engine 17.

As shown in FIG. 6, the right side portion 22f of the exhaust pipe 22 can extend backward and upward. The right side portion 22f can include a large diameter portion 22g in a liner part near a center of the right side portion 22f, and a catalytic device 24 can be stored in the expanded portion 22g as shown in FIGS. 5 and 6. The catalytic device 24 can clean exhaust gas discharged from the engine 17.

As shown in FIG. 2, the catalytic device 24 can be stored in the right side portion 22f on an opposite side to the cam chain chamber 17f of the engine 17 with respect to a widthwise direction. The exhaust side end portion 22b of the right side portion 22f can be connected with the muffler 23 through a fastening member 51.

The motorcycle 1 according to the first embodiment can include the exhaust pipe 22 having the above-described structure, and therefore the exhaust pipe 22 can have a sufficient length based on a length of the left side portion 22d that extends forward from the back side of the engine 17, and a length of the right side portion 22f that extends backward from the front of the engine 17. The exhaust pipe 22 can have a greater length than in a case where the exhaust pipe 22 is formed to extend backward from a back side of the engine 17. Furthermore, the front side portion 22e that extends in front of the engine 17 in a widthwise direction can further increase a length of the exhaust pipe 22. In this way, the exhaust pipe 22 can be arranged to surround the engine 17, so that the exhaust pipe 22 can be connected to the back side of the engine 17 while the exhaust pipe 22 can have a sufficient length and the exhaust silencing effect can further be improved.

As described in the foregoing, the cylinder axial line L1 of the engine 17 can be inclined backward. The front side portion 22e can be arranged in a space created in front of the engine 17 by the backward inclination of the cylinder axial line L1, so that weight can be concentrated in a center of a body of the motorcycle 1.

The right side portion 22f can be provided above the bottom of the engine 17, so that the minimum ground clearance of the right side of the motorcycle 1 can be raised. In this way, reduction in the angle (banking angle) at which the motorcycle 1 can be inclined to the right attributable to an arrangement of the exhaust pipe 22 on the right side of the engine 17 can be prevented.

Furthermore, the right side portion 22f can be provided above the crank axial center 0. In this way, the minimum ground clearance of the right side of the motorcycle 1 can be raised.

In addition, not only the right side portion 22f and the front side portion 22e but also substantially all the portions of the exhaust pipe 22 can be provided above the bottom surface of the engine 17, so that the minimum ground clearance of the motorcycle 1 can be raised.

Furthermore, substantially all the portions of the exhaust pipe 22 can be provided above the crank axial center O of the engine 17, so that the minimum ground clearance can further be raised.

The front side portion 22e of the exhaust pipe 22 can be extended between the engine 17 and the down frame 9. Thus, the space created between the engine 17 and the down frame 9 can be used effectively. The exhaust pipe 22 can be provided behind the down frame 9, so that the pipe can be protected against pebbles and sand raised by the front wheel 15.

The front side portion 22e of the exhaust pipe 22 can be provided under the radiator 21, so that the space can be used effectively.

The catalytic device 24 can be provided in the right side portion 22f that is on the opposite side to the cam chain chamber 17f of the engine 17 with respect to a widthwise direction. The catalytic device 24 can be provided in a space formed on the right side of the cylinder part 17b where the cam chain chamber 17f is not provided.

### Second Embodiment

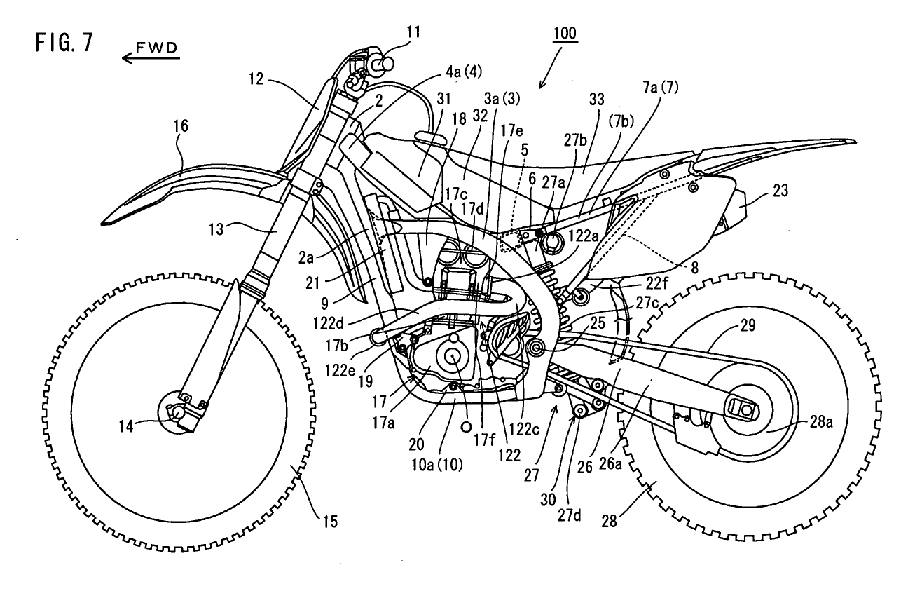

Referring to FIGS. 7 to 11, a structure of a motorcycle 100 according to a second embodiment of the present invention will be described. The second embodiment is different from the first embodiment in that an exhaust pipe 122 can be extended in front of the down frame 9. In the second embodiment, portions that are the same as those of the first embodiment are denoted by the same reference numbers, and their description will not be repeated in some cases.

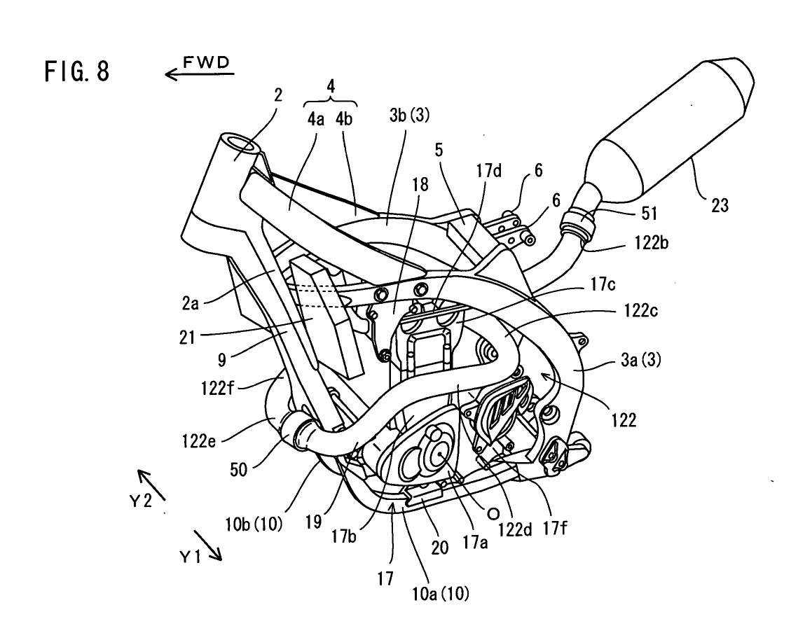

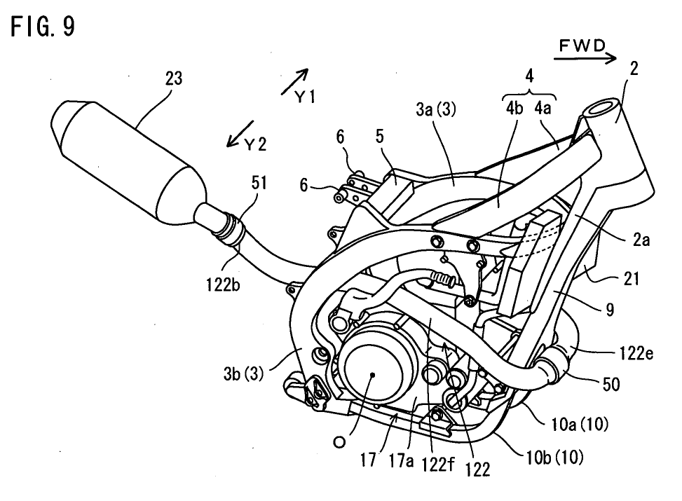

FIG. 7 is a left side view of the motorcycle 100 according to the second embodiment. FIG. 8 is a perspective view of a frame structure of the motorcycle 100 including the exhaust pipe 122 as seen obliquely from the upper left. FIG. 9 is a perspective view of the frame structure of the motorcycle 100 including the exhaust pipe 122 as seen obliquely from the upper right.

As shown in FIGS. 7 to 9, the frame structure includes a head pipe 2, a main frame 3, a tank frame 4, a seat frame 7, a down frame 9, and a lower frame 10 similarly to the first embodiment. The structure and arrangement of an engine 17, an air cleaner 31, a fuel tank 32, and a seat 33 are the same as those of the first embodiment. An engine side end portion 122a of the exhaust pipe 122 can be connected to a back side of the cylinder head 17c of the engine 17.

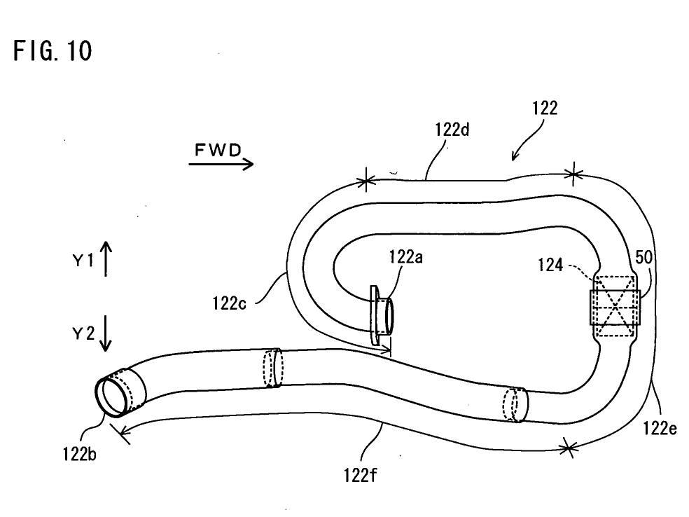

FIG. 10 is a plan view of the exhaust pipe 122. The engine side end portion 122a of the exhaust pipe 122 can be connected to a back side of the engine 17. The exhaust pipe 122 can include a U-shaped portion 122c that extends backward (in an opposite direction to a direction denoted by the arrow FWD) from the end portion 122a and is then curved to the left. The exhaust pipe 122 can include a left side portion 122d that extends forward on a left side of the engine 17 (on a side indicated by the arrow Y1). The exhaust pipe 122 can include a front side portion 122e that is connected to a downstream side (front end) of the left side portion 122d and then extends in front of the down frame 9 to the right side of the engine 17 (in a direction indicated by the arrow Y2). The exhaust pipe 122 can include a right side portion 122f that is connected to a downstream side of the front side portion 122e and extends backward on the right side of the engine 17 (on a side indicated by the arrow Y2). An exhaust side end portion 122b of the exhaust pipe 122 can be connected with a muffler 23.

As shown in FIG. 10, the front side portion 122e of the exhaust pipe 122 can be divided into right and left sections in a widthwise direction near the center of the front side portion 122e. The two sections of the front side portion 122e can be connected by a fastening member 50. The U-shaped portion 122c, the left side portion 122d, and the left section of the front side portion 122e can be formed to be continuous. The right section of the front side portion 122e and the front part of the right side portion 122f can be formed to be continuous.

As shown in FIGS. 7 to 9, the exhaust pipe 122 can be arranged to surround a front part of the down frame 9 provided in front of the engine 17. More specifically, the left side portion 122d of the exhaust pipe 122 extends forward from a connection portion with the U-shaped portion 122c and then to the front of the down frame 9 on a left side of the engine 17. Furthermore, the front side portion 122e of the exhaust pipe 122 extends in front of the down frame 9 in a widthwise direction of the motorcycle 1.

As shown in FIG. 7, the left side portion 122d of the exhaust pipe 122 can be formed to extend forward and then obliquely forward and downward. In this way, the front side portion 122e of the exhaust pipe 122 can be arranged to be separated from the front fender 16 and the front wheel 15, so that it does not interfere with the front fender 16 and the front wheel 15 provided ahead of the down frame 9.

As shown in FIGS. 9 and 10, the front side portion 122e can include a portion that has a larger diameter near its center portion. A catalytic device 124 used to clean exhaust gas can be provided in the enlarged-diameter portion of the front side portion 122e.

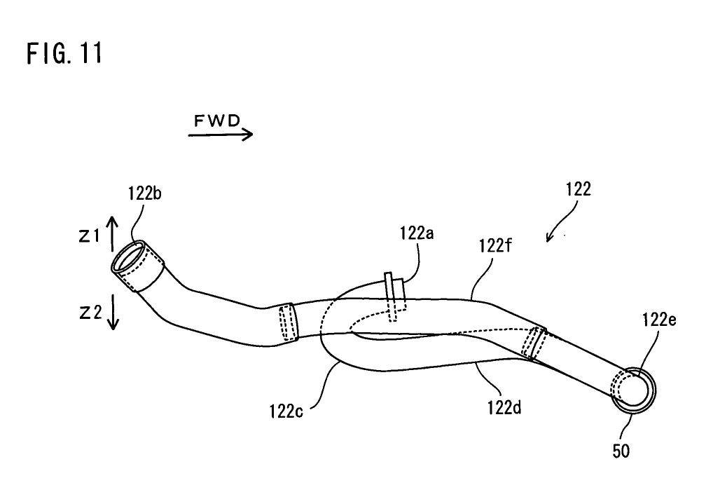

FIG. 11 is a right side view of the exhaust pipe 122. As shown in FIG. 11, the front side portion 122e can be arranged in the lowest position among all the portions that form the exhaust pipe 122. As shown in FIG. 7, the front side portion 122e can be positioned above a bottom surface of the engine 17. More specifically, the front side portion 122e can be positioned above the crank axial center O of the engine 17. In other words, substantially all the portions of the exhaust pipe 122 can be provided above the bottom surface of the engine 17. More specifically, substantially all the portions of the exhaust pipe 122 can be provided above the crank axial center O of the engine 17. An end portion 122b of the right side portion 122f can be connected with the muffler 23 through the fastening member 51 (see FIG. 8).

According to the second embodiment, the exhaust pipe 122 can be provided to extend ahead of the down frame 9 as described above, so that the exhaust pipe 122 can have an even larger length.

The catalytic device 124 can be provided in the front side portion 122e that extends in front of the down frame 9. In this way, the catalytic device 124 can be provided nearer to the engine 17 than would be the case if the catalytic device 124 were provided in the right side portion 122f or in the muffler 23. Exhaust gas from the engine 17 can be cleaned by the catalytic device 124 while the exhaust gas is in a high temperature state, and therefore the exhaust gas can effectively be cleaned.

### Third Embodiment

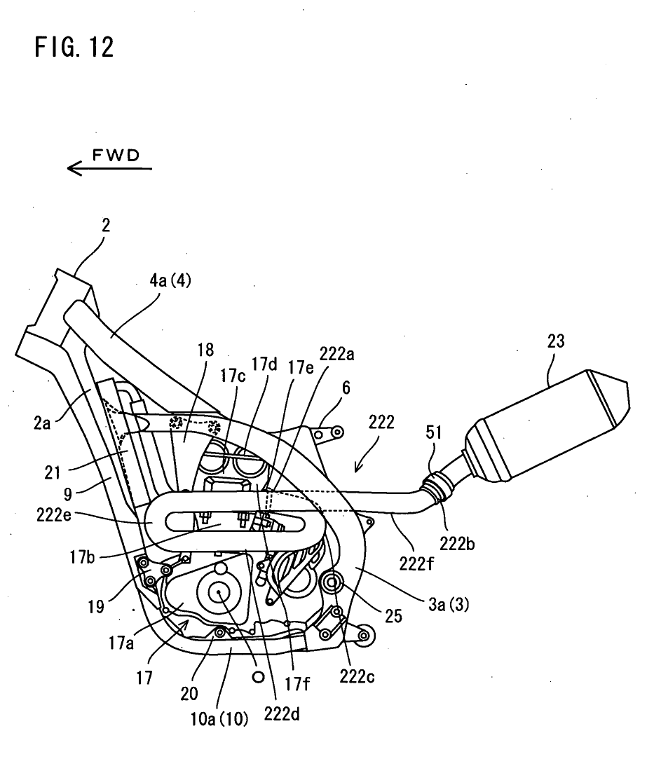

FIG. 12 is a left side view of structure of an exhaust pipe in a motorcycle according to a third embodiment of the present invention. The third embodiment is different from the first or second embodiment in that an exhaust pipe 222 can be folded on a left side of the engine 17. In the third embodiment, portions that are the same as those of the first embodiment are denoted by the same reference numbers, and their description will not be repeated.

An end portion 222a of the exhaust pipe 222 can be connected to a back side of the engine 17. The exhaust pipe 222 can include a U-shaped portion 222c that extends backward and downward from the end portion 222a and is then folded forward. The exhaust pipe 222 can include an extension portion 222d that extends forward on a left side of the crank case 17a of the engine 17. The exhaust pipe 222 can include a U-shaped portion 222e that is connected to a downstream side (front end) of the extension portion 222d and then folded upward. The exhaust pipe 222 can include an extension portion 222f that is connected to a downstream side of the U-shaped portion 222e and extends backward on a left side of a cylinder portion 17b.

An end portion 222b of the extension portion 222f can be connected with a muffler 23. The U-shaped portion 222e can be provided on a left side of a radiator 21 and behind a down frame 9.

According to the third embodiment, the exhaust pipe 222 can be formed in the above-described manner, so that a length of the exhaust pipe 222 can be large enough based on a length of the extension portion 222d that extends forward from the back side of the engine 17 and a length of the extension portion 222f that extends backward from a front of the engine 17.

### Fourth Embodiment

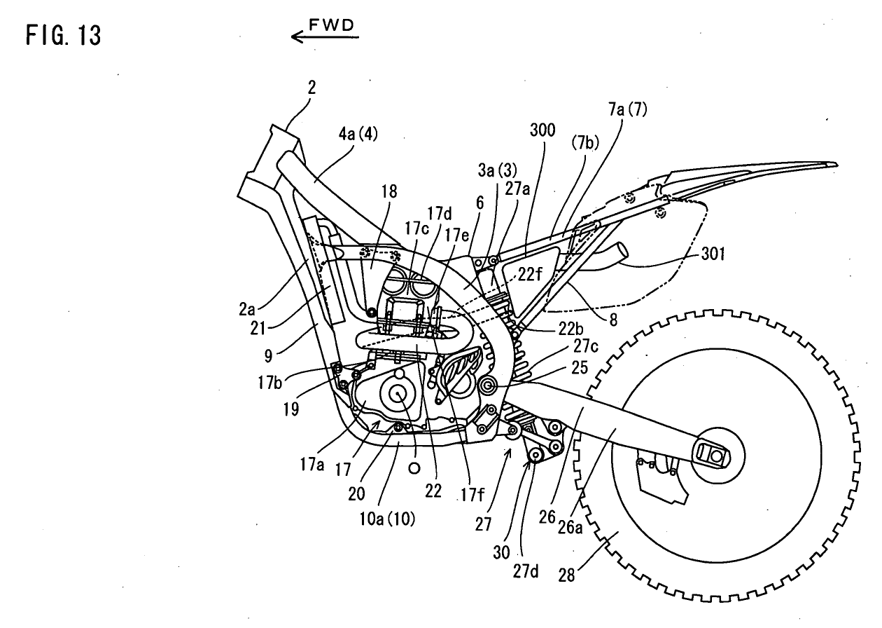

FIG. 13 is a left side view of structure of an exhaust chamber in a motorcycle according to a fourth embodiment of the present invention. The fourth embodiment is different from the first embodiment in that an exhaust or expansion chamber 300 provided between the rear cushioning member 27 and the rear wheel 28 can be connected with the end portion 22b of the exhaust pipe 22. In the fourth embodiment, portions that are the same as those of the first embodiment are denoted by the same reference numbers, and their description will not be repeated.

The end portion 22b of the right side portion 22f of the exhaust pipe 22 can be connected with the exhaust chamber 300. The exhaust chamber 300 can control exhaust noise by expanding exhaust gas from the engine 17. The exhaust chamber 300 can be provided ahead of the rear wheel 28 and in a space surrounded by the rear cushioning member 27, a seat frame 7 and a back stay 8. A tail pipe 301 used to discharge exhaust gas from the exhaust pipe 22 can be attached at a back of the exhaust chamber 300.

According to the fourth embodiment, the exhaust chamber 300 can be provided in the space surrounded by the rear cushioning member 27, the seat frame 7, and the back stay 8. The exhaust chamber 300, which can-be heavy, can be provided near the engine 17, which can also be heavy. In this way, weight balance can be improved.

While the above description of the first to fourth embodiments has referred to an off-road-type motorcycle (for off-road racing) as one illustrative example, as noted previously, embodiments of the invention can be implemented in a variety of forms, including an on-road-type motorcycle such as a motor scooter, or other types of vehicles such as an automobile, a tricycle, or an ATV (All Terrain Vehicle) that have an exhaust pipe connected to a back side of an engine.

According to the first, second and fourth embodiments, the exhaust pipe can be arranged to extend forward on the left side of the engine, then in front of the engine, and then backward on the right side of the engine. In an arrangement symmetric to the foregoing, the exhaust pipe may be arranged to extend forward on the right side of the engine, then in front of the engine and then backward on the left side of the engine.

According to the third embodiment, the extension portion of the exhaust pipe can be provided on the left side of the engine. Alternatively, the extension portion of the exhaust pipe can be provided on the right side of the engine.

According to the fourth embodiment, the tail pipe can be connected to the back of the exhaust chamber and exhaust gas can be discharged outside, while a muffler connected to the tail pipe may additionally be connected. This can further reduce exhaust noise.

It will be apparent to one skilled in the art that the manner of making and using the claimed invention has been adequately disclosed in the above-written description of the preferred embodiments taken together with the drawings.

It will be understood that the above description of the preferred embodiments of the present invention are susceptible to various modifications, changes and adaptations, and the same are intended to be comprehended within the meaning and range of equivalents of the appended claims.

What is claimed is:

1. A motorcycle, comprising:
an engine; and
an exhaust pipe connected to a back side of the engine,
the exhaust pipe comprising:
a first portion connected to the back side of the engine and extending forward from the back side of the engine on one side of the engine, with respect to a widthwise direction of the motorcycle;
a second portion connected to a downstream side of the first portion and extending in front of the engine from the one side to another side, with respect to the widthwise direction of the motorcycle; and
a third portion connected to a downstream side of the second portion and extending to the back side of the engine along a body of the motorcycle.

2. The motorcycle according to claim 1, wherein
at least the third portion of the exhaust pipe is provided above a bottom surface of the engine.

3. The motorcycle according to claim 2, wherein
an entirety of the exhaust pipe is provided above the bottom surface of the engine.

4. The motorcycle according to claim 1, further comprising:
a head pipe; and
a frame portion provided ahead of the engine and extending backward and downward from the head pipe,
the second portion including a portion extending between the engine and the frame portion.

5. The motorcycle according to claim 4, wherein
the engine includes a cylinder having an axial line inclined backward with respect to a substantially vertical line.

6. The motorcycle according to claim 4, further comprising a radiator to cool the engine, wherein the second portion is provided under the radiator.

7. The motorcycle according to claim 4, wherein
the engine includes a cam chain chamber provided on the one side of the motorcycle; and
the exhaust pipe comprises a catalytic device provided in the third portion arranged on the other side of the motorcycle.

8. The motorcycle according to claim 1, further comprising:
a head pipe; and
a frame portion provided ahead of the engine and extending backward and downward from the head pipe, wherein
the second portion comprises a portion that extends in front of the frame portion.

9. The motorcycle according to claim 8, wherein
the exhaust pipe includes a catalytic device provided in the exhaust pipe ahead of the back side of the engine.

10. The motorcycle according to claim 9, wherein
the exhaust pipe includes a catalytic device provided in the second portion.

11. The motorcycle according to claim 1, further comprising:
a rear wheel;
a rear cushioning member provided between the engine and the rear wheel; and
an expansion chamber provided between the rear cushioning member and the rear wheel and connected to a rear end of the exhaust pipe.

12. The motorcycle according to claim 1, wherein
the engine is a single-cylinder engine.

13. The motorcycle according to claim 1, wherein
the motorcycle is a motorcycle for off-road racing.

14. An exhaust pipe for a vehicle, comprising:
a rear portion to connect to a rear part of an engine;
an intermediate portion to extend from the rear portion along a first side of the engine;
a front portion to extend from the intermediate portion along a front of the engine; and
an exhaust portion to extend from the front portion along a second side opposite the first side.

15. The exhaust pipe of claim 14, wherein when in place on a vehicle, the front portion passes between the engine and a frame of the vehicle.

16. The exhaust pipe of claim 14, wherein the rear portion includes a U-shaped portion.

17. The exhaust pipe of claim 16, wherein when in place on a vehicle, the U-shaped portion extends toward a rear of the vehicle.

18. The exhaust pipe of claim 14, wherein the exhaust portion is to connect to a muffler.

19. The exhaust pipe of claim 14, wherein the vehicle is a motorcycle.

20. A vehicle exhaust pipe formed to connect to a rear part of an engine of the vehicle, and wrap around a front of the engine to exhaust toward a rear of the engine.
